(19) United States
(12) Patent Application Publication
(10) Pub. No.: US 2006/0104372 A1
(43) Pub. Date: May 18, 2006

(54) Coding system

(75) Inventors: Willem Marie Julia Marcel Coene, Eindhoven (NL); Albert Hendrik Jan Immink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/540,688

(22) PCT Filed: Nov. 26, 2003
(86) PCT No.: PCT/IB03/05498

§ 371 Date: Jun. 24, 2005

(30) Foreign Application Priority Data
Dec. 30, 2002 (EP) 02080583.4

(51) Int. Cl. H04K 1/10

(52) U.S. Cl. 375/260

(57) ABSTRACT

The present invention relates to a coding strategy for joint modulation coding and ECC coding. It relates in particular to the situation where 2D coding is performed along one-dimensionally evolving strips containing a number of bit rows in the radial direction of the strip, which is orthogonal to the former direction. The idea further relates to high-rate modulation coding. According to the invention, a strip is built up by an alternation of two basic sub-units, each with their own modulation code. The first sub-unit comprises a larger number of bit rows, and its (high-rate) modulation code has a high coding efficiency realized through the use of large codewords. The second sub-unit comprises a single or only few bit rows, and its modulation code has a lower efficiency, which makes it much less sensitive to error-propagation: another function of the sub-unit of the second type is to glue sub-units of the first type together while maintaining the 2D constraint also at the boundaries of the subunits of the first type. The first sub-unit relates to most or all of the source data, and is encoded first, prior to ECC coding. The second sub-unit relates to the ECC parities, and possibly the remainder of the source data. Both at the encoder and the decoder, special measures are taken related to the precise order of both modulation code encoders (and decoders), and of the ECC encoder (and decoder).

The present invention relates to an encoding apparatus and a corresponding method for multi-dimensionally encoding a user data stream of user data into a channel data stream, in particular for two-dimensionally encoding a user data stream. The invention relates further to a corresponding decoding apparatus and method. Further, the invention relates to a signal showing the data structure of the encoded channel data stream and storage medium storing such a signal. Finally, the invention also relates to a computer program for implementing said methods to be executed by a computer.

In digital optical recording, channel encoding is accomplished in successive steps. Two main parts can be distinguished: the transmitting part, including the write-channel in which a user stores data on a recording medium or transmits data via a transmission line, and the receiving part, including the read-channel in which the same or another user tries to restore the original information by reading out the data written on the medium or transmitted via the transmission line.

In order to realise a sufficiently high level of reliability, the data is first encoded before being stored or transmitted. This channel encoding typically comprises an error correction code (ECC) and a modulation code (MC). The channel encoder at the transmitting part consists of an error-correction-code encoder (ECC-encoder) and the modulation-code encoder (MC-encoder), usually cascaded one after the other in that order.

Located at the receiving part of the channel are the physical signal detection with a read head scanning the information on the medium or receiving the data from the transmission line, followed by a bit detection module, which aims to derive the written or transmitted bits (also called channel bits) from the measured signals as reliably as possible. These elements precede the channel decoding, which consists of the respective counterparts of the elements at the transmitting part, with first the MC-decoder, followed by the ECC-decoder.

The ECC adds redundancy in the form of parity symbols, which makes it possible to restore the correct information in the presence of channel imperfections like random errors and/or burst errors that may occur during read-out from the medium or during transmission. The modulation code serves to transform arbitrary (binary) sequences into sequences that possess certain desirable properties.

In traditional 1D optical recording, for the case of a high-rate modulation code, that is a code with a code-rate close to 1, the above described traditional encoding and decoding system is not very well suited. In order to achieve the high rate, the modulation code encoder needs to use very long codewords that comprise (at the user side) a (very large) number of consecutive ECC symbols (or bytes). Supposing that a single channel error occurs in the read channel, like a simple shift of a transition in the as-detected channel bitstream, this error will affect one channel codeword, which will lead to a number of erroneous bytes prior to ECC decoding. In other words, for high-rate modulation codes, the traditional system will suffer from large error propagation.

W. G. Bliss, “Circuitry for Performing Error Correction Calculations on Baseband Encoded Data to Eliminate Error Propagation”, IBM Techn. Discl. Bul., vol. 23, pp. 4633-4634, 1981 describes a variant of the encoding and decoding system that does not suffer from the above drawbacks. In the encoder of the Bliss-scheme two modulation code encoders are used instead of a single one. One of them is positioned before the ECC encoder and has a high efficiency. The ECC encoder generates parity data based on the output of the first modulation code encoder. The other modulation code encoder is positioned after the ECC encoder, has a lower efficiency and encodes the parity data generated by the ECC encoder. The constrained sequence for the parity part, produced by the second modulation code encoder, is then cascaded with the constrained sequence for the data part, produced by the first modulation code encoder. The decoder of the Bliss-scheme correspondingly comprises two modulation code decoders, one positioned before an ECC decoder and the other one positioned after the ECC decoder producing the corresponding user data.

In two-dimensional (2D) coding as it is described in European patent application 02076665.5 (PHNL 020368) which is herein incorporated by reference, the 2D area is divided into strips, which are aligned in a first direction and consist of a number of bit rows. Coding is done in this first direction, and becomes essentially 1-dimensional, that is, the code evolves along one dimension, the tangential direction of the strip. Codewords do not cross the boundaries of a strip. Codewords may be based on a 2D area consisting of Nᵣ rows and N_{c} columns. In strip-based coding strips are constructed so that concatenation of strips in a second direction does not lead to violations of the constraints across the strip boundaries: for this purpose, bit clusters at the boundary of a strip have to satisfy a special boundary constraint. Also a larger strip can be formed by proper stacking of a number of sub-stacks.

As described above, stacking of (sub-)strips on top of each other, that is, free concatenation in the second direction for 2D coding, requires a boundary constraint to be satisfied by the bit clusters at the boundaries of each (sub-)strip. In a number of cases, this is not a very efficient way to go from a coding point of view. Such a case may occur when 2D coding on sub-strips that are three bit-rows high is applied. The 2D constraint at hand may be that certain worst-case patterns may not occur in a sub-strip, that is, for example, three bit rows high. Worst-case patterns are special bit patterns which are more error-prone for the bit detection module of the receiver at the read-part of the channel. However, when sub-strips are stacked one upon each other, at the boundary area of two sub-strips, two other three bit row high areas which overlap with the two sub-strips can be found. For these other three bit row areas, the code constraint may not be satisfied, unless an expensive boundary constraint is applied.

Another variant of the same problem is that worst-case patterns may occasionally also be built up in other directions than the first direction, i.e. in other directions than parallel to the strip, which will be referred to as diagonal worst-case patterns.

It is an object of the present invention to provide an encoding apparatus and method for multi-dimensionally encoding as well as a corresponding decoding apparatus and method by which the above problems can be avoided, in particular by which coding constraints can also be fulfilled at boundary areas, by which error propagation can be efficiently prevented and by which worst-case bit patterns can be avoided.

This object is achieved according to the present invention by an encoding apparatus as claimed in claim 1, comprising:

a first modulation code encoding unit having a high code-rate for modulation code encoding said user data into first modulation data,

an ECC encoding unit for ECC encoding said first modulation data obtaining ECC parity data,

a second modulation code encoding unit having a lower code-rate than said first modulation code encoding unit for modulation code encoding said parity data into second modulation data,

a modulation data combination unit for combining said first and second modulation data into said channel data stream comprising at least two bit rows one-dimensionally evolving along a first direction and being aligned with each other along at least a second direction, wherein said first and second modulation data (BS1, BS2) are arranged according to a predetermined order, in particular alternately arranged, in said second direction.

A corresponding decoding apparatus is defined in claim 11 and comprises:

a channel data separation unit for separating said channel data into first and second channel data,

a second modulation code decoding unit having a low code-rate for modulation code decoding said second channel data into ECC parity data,

an ECC decoding unit for ECC decoding said first channel data and said ECC parity data obtaining ECC decoded first channel data, and

a first modulation code decoding unit having a higher code-rate than said second modulation code decoding unit for modulation code decoding said ECC decoded first channel data into ECC decoded user data forming said user data stream.

Corresponding methods are defined in claims 13 and 14. A signal according to the present invention is defined in claim 15 and 16 which can be stored on a record carrier, such as a CD, DVD or BD disk, as defined in claim 17. A computer program for implementing the methods according to the invention is defined in claim 18.

The invention is based on the idea to use a stacking of at least two types of basic sub-units (of modulation data): stacking of these sub-units in the first direction yields the complete channel data stream, in particular a 2D strip in 2D coding. The data of the first sub-unit are encoded with the high-rate error-propagation-sensitive code. The data of the second sub-unit are encoded with a lower-rate code with corresponding shorter codewords and thus less error propagation. The purpose of this second type of sub-unit is two-fold: a first purpose is to encode the parities that are generated by the ECC encoder applied on the first modulation data in all sub-units of the first type, preferably, as defined in a preferred embodiment, together with remaining user data that have to be encoded since not encoded by the first modulation code. A second purpose is to “glue” successive sub-units of the first type together so that (i) the constraint that was applied on the sub-units of the first type also applies for the boundary areas and that (ii) occasional building-up of diagonal worst-case patterns in directions that are oblique with the first direction along the 2D strip is also prohibited.

According to the invention 2D code-constraints are considered that require relatively little overhead, that is, the related capacity of the code-constraint is close to 1. The capacity of a code-constraint is the theoretical upper-bound for the rate of a code with such a code-constraint. For such a high-rate code to be as efficient as possible, very long codewords are required in the first modulation code as are, for instance, used in enumerative channel coding. By use of the invention, such very long codewords, leading to the problem of error-propagation in the known coding scheme, can be applied, but do not lead to error-propagation problems.

According to the invention the modulation data combination unit which is adapted for combining the first and second modulation data according to a predetermined order so that a decoding apparatus can decode the received channel data stream by use of the information of the predetermined order. Preferably, the first and second modulation data are alternately arranged in the second direction, preferably orthogonal to the direction of the 2D strip, when combined into the channel data stream. Thus, the one type of modulation data fulfils the task of “glueing” the other type of modulation data together so that code constraints are also fulfilled at boundary areas between different parts of the same modulation data when combining them into multi-dimensional channel data stream.

Preferred embodiments of the invention are defined in the dependent claims. While generally all user data are modulation code encoded by the first modulation code encoder, it is also possible that the user data are split into first and second user data and that only the first user data are modulation code encoded by the first modulation code encoder and that the second (remaining) user data are, together with the ECC parity data, modulation code encoded by the second modulation code encoder. In this embodiment, the ECC parities are not only obtained from the first modulation coded encoded data, but also from the second user data which are also inputted into the ECC encoder. The decoding apparatus will be built in the complementary way.

While the invention is generally applicable for multi-dimensionally encoding a user data stream, a preferred application lies in the field of 2D encoding. Therein the channel data of the channel data stream are located at bit positions of a two-dimensional lattice which comprises a channel strip of at least two bit rows one-dimensionally evolving along of first direction and being aligned with each other along a second direction.

A preferred implementation thereof uses a two-dimensional hexagonal lattice where each bit, except for bits in the boundary bit rows of a larger 2D strip, has six nearest neighbouring bits together with the central bit forming a bit cluster. However, the invention is also applicable to any other regular 2D lattice, such as a square lattice where each bit has generally four nearest neighbours. A hexagonal lattice has the advantage that the bit density can be very high.

The first modulation data are preferably arranged along a first two-dimensional modulation strip (or sub-unit) of at least two, but preferably three bit rows. The second modulation data are preferably arranged along a second modulation strip (or sub-unit) of at least one bit row. The bit rows evolve one-dimensionally along the same first direction and are preferably aligned which each other along a second direction which is essentially orthogonal to the first direction.

A particular preferred embodiment of a modulation data combination unit for 2D encoding is defined in claim 7. The channel data stream obtained by said modulation data combination unit comprises three first modulation strips (or sub-units) each having three bit rows and two second modulation strips (or sub-units) each having one bit row wherein said second modulation strips (or sub-units) are arranged between said first modulation strips (or sub-units).

Preferably the first modulation code has a high code-rate close to 1 and thus uses long codewords. One embodiment of such a code based on a modulation strip or sub-unit of three bit-rows has a 152→153 code mapping, preferably with an extra 3-bit symbol used as re-alignment symbol, which can, for instance, be implemented using enumerative channel coding.

Correspondingly the second modulation code having a much lower code-rate users short codewords. A particular implementation is a 12→13 modulation code.

The invention will now be explained in more detail with reference to the drawings in which:

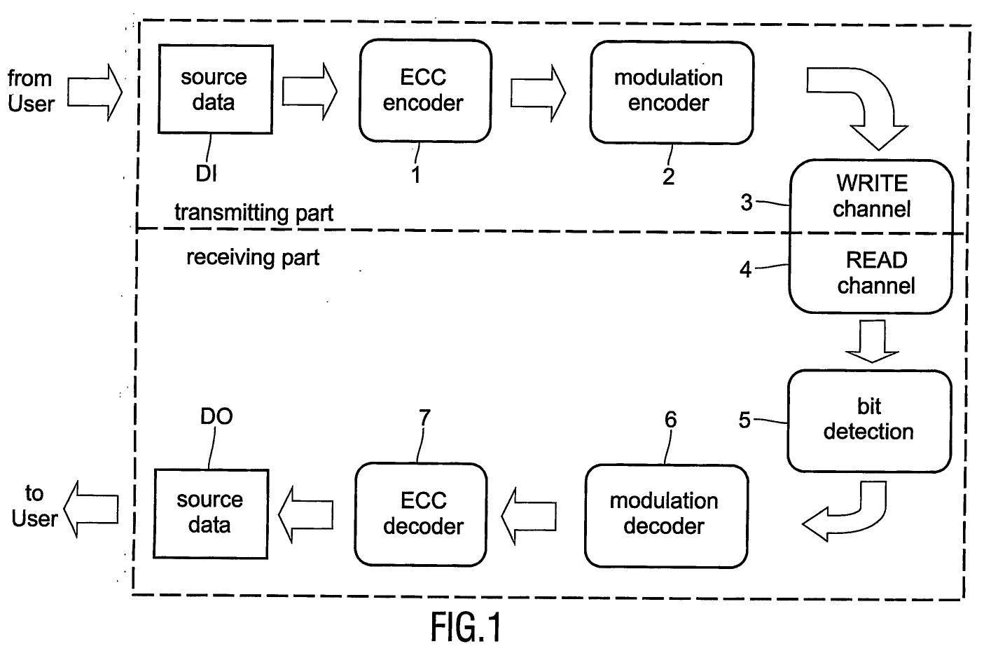

FIG. 1 shows the typical layout of a coding system,

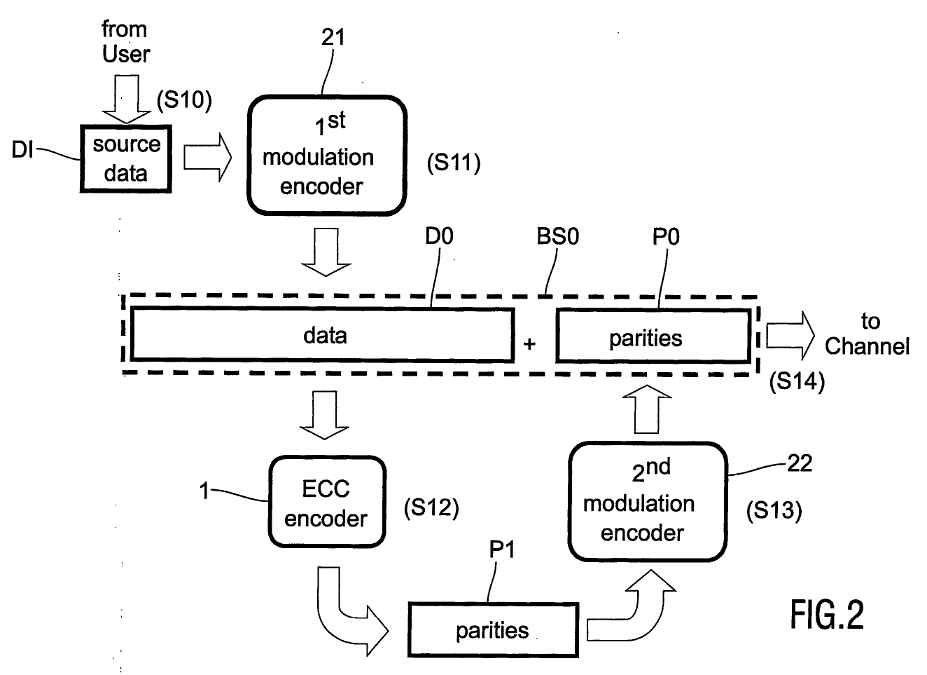

FIG. 2 shows a block diagram of a known encoding apparatus,

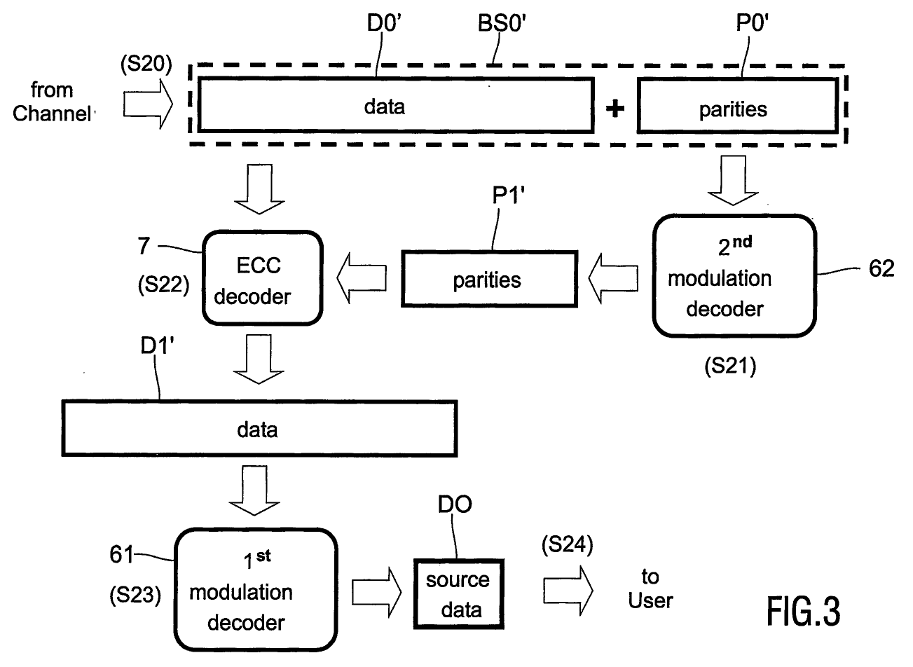

FIG. 3 shows a block diagram of a known decoding apparatus,

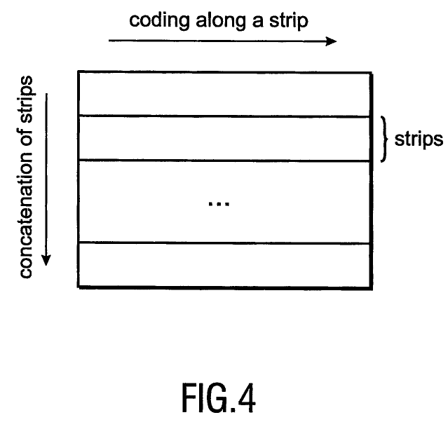

FIG. 4 illustrates strip-wise coding used in 2D encoding,

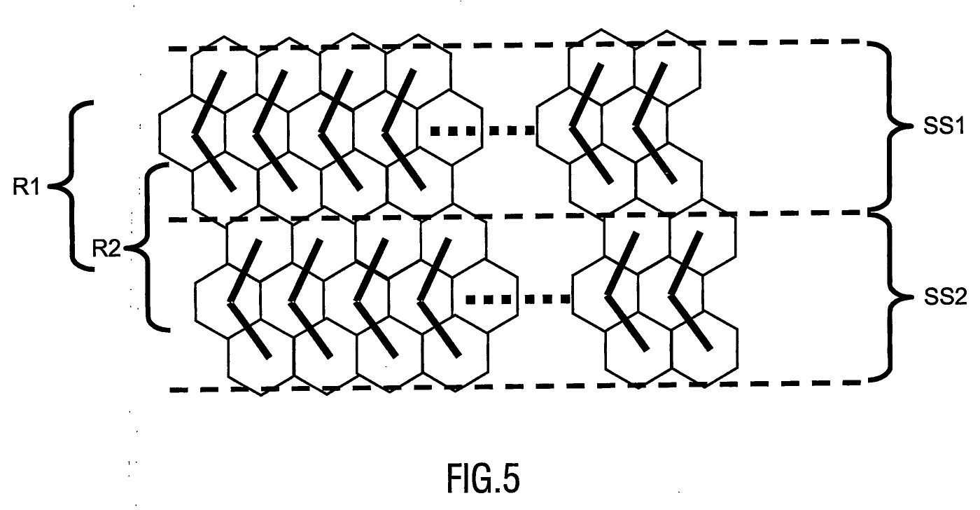

FIG. 5 illustrates the problem with code constraints at the boundary of two strips,

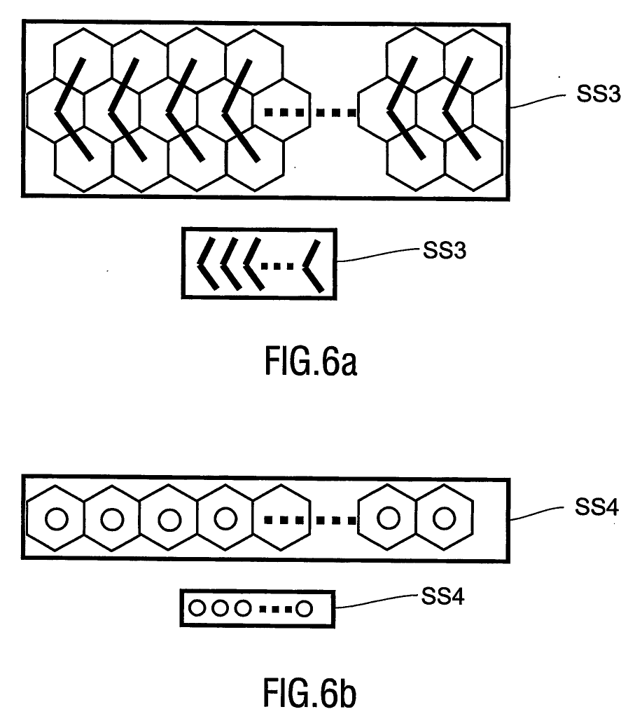

FIG. 6 shows two modulation strips used according to the present invention,

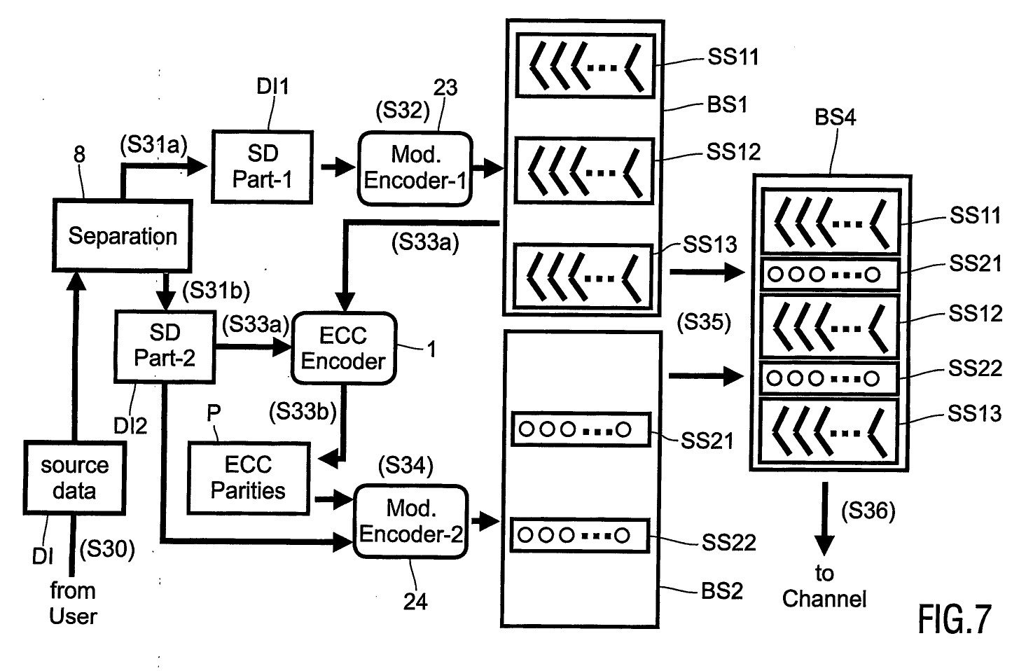

FIG. 7 shows a block diagram of an encoding apparatus according to the present invention,

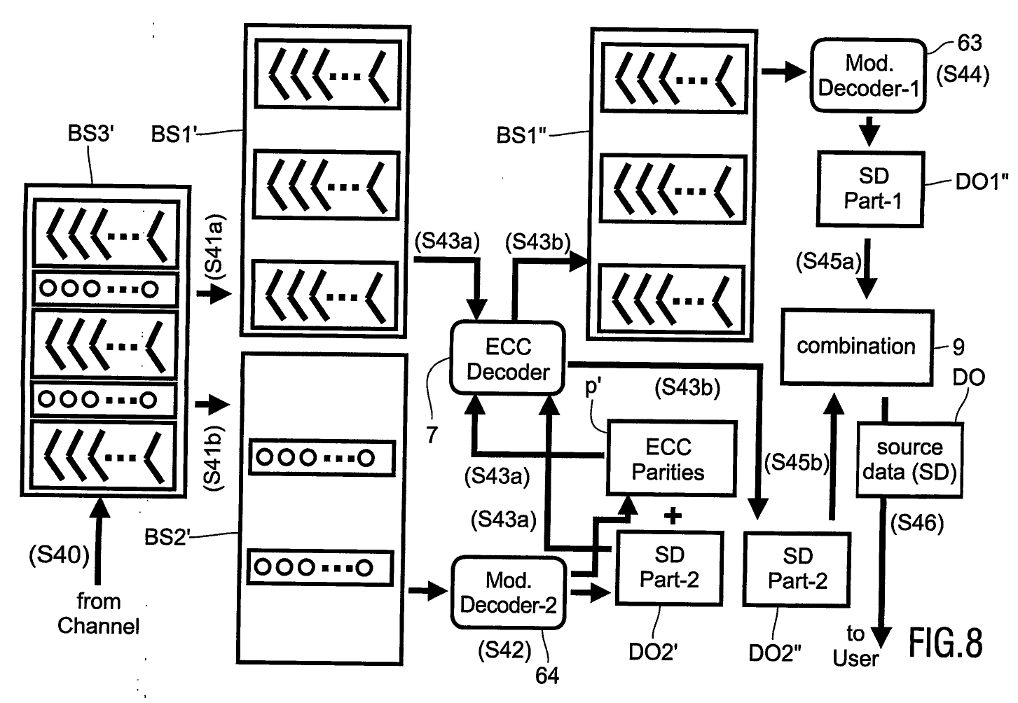

FIG. 8 shows a block diagram of a decoding apparatus according to the present invention.

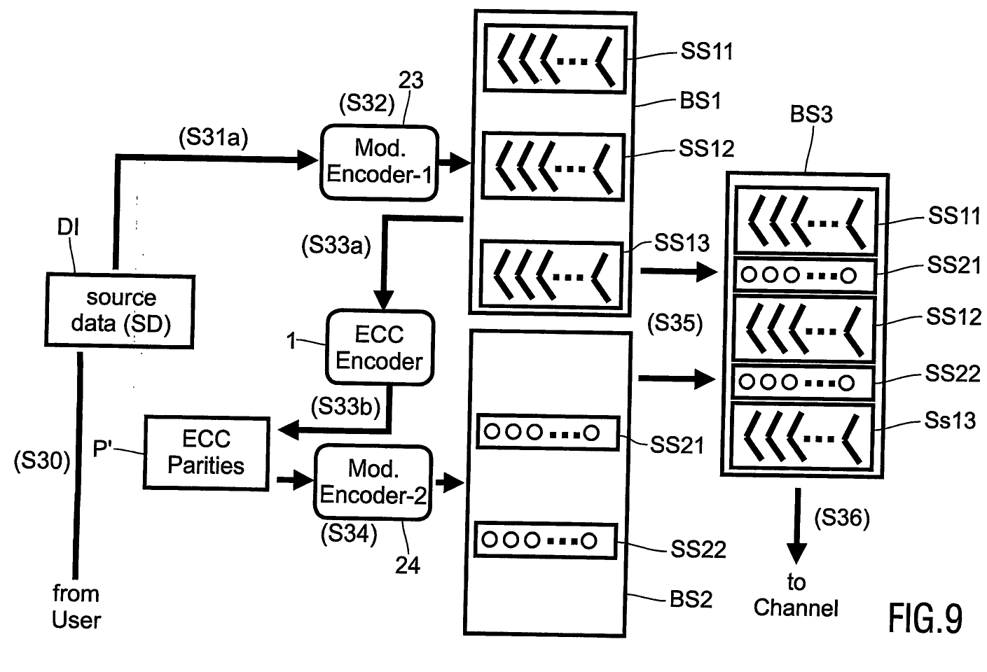

FIG. 9 shows a block diagram of another embodiment of an encoding apparatus according to the present invention, and

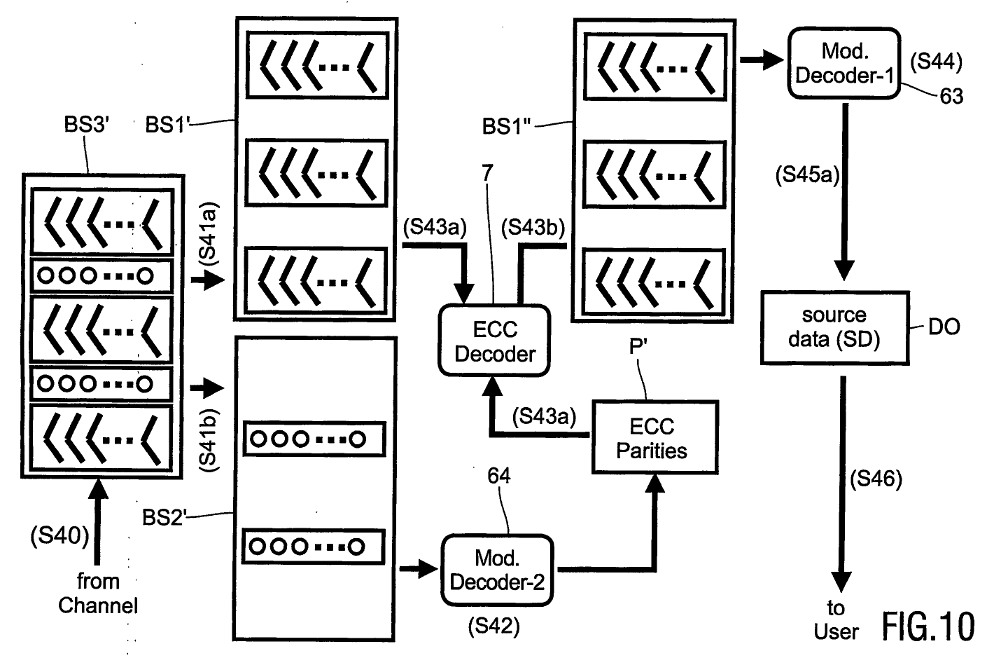

FIG. 10 shows a block diagram of another embodiment of a decoding apparatus according to the present invention.

FIG. 1 shows the typical layout of a coding system used in optical recording as a simple block diagram. Two parts can be distinguished: the transmitting part, including the write-channel 3 in which a user stores data on the recording medium (or transmits data via a transmission channel like the internet), and the receiving part of the system, including the read-channel 4 in which the same or another user tries to restore the original information by reading out the data written on the medium (or transmitted over a transmission channel).

In order to realise a sufficiently high level of reliability, the user data DI (also called source data) is first encoded before being stored or transmitted. This channel encoding typically comprises an error correcting code (ECC) and a modulation code (MC). The channel encoder at the transmitting end thus consists of the ECC encoder 1 and the modulation code encoder 2, usually cascaded one after the other in that order.

Located at the receiving end of the channel are the physical signal detection with the read head (not shown) scanning the information on the medium, followed by the bit detection module 5, which aims to derive the written bits (also called channel bits) from the measured signals as reliably as possible. These blocks precede the channel decoding, which consists of the respective counterparts of the modules at the transmitting end, with first the modulation code decoder 6, followed by the ECC decoder 7 which finally outputs the decoded user data DO to the user.

A block diagram of the known encoding and the decoding scheme disclosed in the above mentioned article of W. G. Bliss are shown in FIGS. 2 and 3, respectively. In the encoder of the Bliss-scheme shown in FIG. 2, two modulation codes instead of a single one are used. The inputted (step S10) source data DI are inputted to the first modulation code encoder 21 (step S11) which is positioned before the ECC encoder 1, unlike the traditional layout shown in FIG. 1. The first modulation code has a (very) high efficiency, which means that the high rate of this code is close to the high capacity of the channel constraint for which the modulation code is being designed: this requires the aforementioned use of long codewords, that is, the first modulation code suffers from error propagation.

Then, the ECC encoder 1 (step S12) operates on the constrained sequence of modulation data D0 that is produced by the first modulation code encoder 21. Because of the high rate of the latter, the ECC encoding is only a tiny bit less effective than in the case the ECC encoding would be applied on the pure source data DI without the correlation added by the first modulation code encoder 21. The parities P1 generated by the ECC encoder 1 are then encoded by the second modulation code encoder 22 (step S13), which has not that very high rate of the first modulation code encoder 21, but which suffers much less from error-propagation. The constrained sequence for the parity part P0, produced by the second modulation code encoder 22, is then cascaded (step S14) with the constrained sequence for the data part D0 produced by the first modulation code encoder 21, resulting in the channel bitstream BS0. The cascading process might require some merging bits to “glue” the two bitstreams D0 and P0 together.

In the decoder of the Bliss-scheme as shown in FIG. 3, the part of the channel bitstream BS0′ corresponding to the parities P0′ received from the channel (step S20) is decoded first by the channel demodulator 62 for the second demodulation code (step S21). Then, the ECC decoder 7 (step 22) operates with as input the (demodulated) parities P1′ and the part of the channel bitstream BS0′ corresponding to the data D0′: the ECC decoder 7 produces at its output the error-free channel bitstream D1′ corresponding to the data part. As a last step (step 23), the demodulator 61 of the first channel code produces (with the latter error-free channel bitstream D1′ as input) the corresponding source data D0 for the user (step S24).

According to the present invention strip-based 2D coding is preferably used. The 2D area is divided into strips as shown in FIG. 4. A strip is aligned in a first direction, for instance horizontally, and consists of a number Nᵣ of bit rows together forming a lattice of bit positions as described in the above mentioned European patent application 02076665.5 (PHNL 020368). Coding is done in this first direction, and becomes essentially 1-dimensional, that is, the code evolves along one dimension, the tangential direction of the strip. Codewords do not cross the boundaries of a strip. Codewords may be based on a 2D area consisting of Nᵣ rows and N_{c} columns. In strip-based coding as described in the above mentioned patent application, strips are constructed so that concatenation of strips in the vertical direction does not lead to violations of the constraints across the strip boundaries: for this purpose, the bit clusters at the boundary of a strip have to satisfy a special boundary constraint. It should be noted that a larger strip can be built up by proper stacking of a number of sub-strips.

As described above, stacking of (sub-)strips on top of each other (that is, free concatenation in the second, for instance radial, direction) requires a boundary constraint to be satisfied by the clusters at the boundaries of each (sub-)strip. In a number of cases, this is not a very efficient way to go from a coding point of view. Such a case may occur when 2D coding is applied on sub-strips that are three bit rows high. The 2D constraint at hand may be that certain worst-case patterns may not occur in a sub-strip that are, for example, three rows high. However, when subs-strips are stacked one upon each other, at the boundary area of two sub-strips, two other three-row high areas which overlap with the two sub-strips can be found. This is illustrated in FIG. 5 where a first and a second sub-strip SS1 and SS2 are shown each comprising three bit rows evolving in horizontal direction and being aligned in vertical direction forming so-called “fish-bones” of three bits each as described in the above mentioned European patent application. For these other three-row areas R1 and R2 crossing the boundary between the concatenated sub-strips SS1, SS2 the code constraint may not be satisfied, unless an expensive boundary constraint is applied. Another variant of the same problem is that worst-case patterns may occasionally also be built up in other than the tangential direction (parallel to the strip), such as diagonal worst-case patterns.

According to the invention a stacking of two types of basic sub-units is used: stacking of these sub-units in the radial direction will yield the complete large 2D strip. One type of sub-unit is a sub-strip consisting of a number of bit rows in the radial direction: this first type of sub-unit SS3 is shown in FIG. 6a for the case of a 3 bit rows height. It is encoded with the high rate error-propagation-sensitive code.

The second sub-unit SS4 is a narrow sub-strip, e.g. consisting of a single bit row as shown in FIG. 6b. The purpose of this second type of sub-unit SS4 is to encode the parities that are generated by the ECC applied on the modulated channel bitstream in all sub-units of the first type, together with remaining source data that has to be encoded (since not encoded by the first modulation code). Another purpose is to glue successive sub-units SS3 of the first type together so that the 2D constraint that was applied on the sub-units SS3 of the first type also applies for the boundary areas; and that occasional building-up of diagonal worst-case patterns is also prevented.

The idea of the present invention is to realize the above two goals with a specifically designed coding scheme which will be described in more detail in the sequel. An embodiment of a 2D coding format for joint ECC and modulation coding according to the present invention will be explained by use of FIGS. 7 and 8.

There are two modulation codes, one for each type of sub-units SS3, SS4. The first modulation code to be applied for the first type of sub-unit SS3 has a high code rate, and is implemented via a coding scheme that uses very long codewords, e.g. via enumerative coding. It is used for the largest fraction of the user data (=source data, which is for instance the output of a source encoder). The second modulation code to be applied for the second type of sub-unit SS4 has a lower coding efficiency, but—unlike the first code—suffers much less from error-propagation. A second purpose of this code is to glue sub-units SS3 of the first type together while maintaining the 2D constraint imposed, also on the boundary area. The second modulation code is used for the ECC parities, and (possibly) for a (small) fraction of the source data.

The different steps at the side of the encoder in the proposed 2D coding scheme are shown in FIG. 7. After inputting the source data DI (step S30) the source data DI is partitioned (steps S31a, S31b) into two parts DI1 and DI2, also denoted as SD Part-1 and SD Part-2 in FIG. 7. Then, the source data Part-1 DI1 is encoded with (the first) modulation code encoder 23 (step S32), producing the channel bitstream BS1 in the distinct sub-units SS11, SS12, SS13 of the first type, in this case each comprising three bit rows. The latter channel bitstream BS1 together with the source data Part-2 DI2 are then the inputs (step S33a) for the ECC encoder 1, which produces ECC parities P′ at its output (step S33b). Subsequently, the source data Part-2 D12 together with the ECC parities P′ are the input of the second modulation code encoder 24 (step S34), producing the channel bitstream BS2 in the distinct sub-units SS21, SS22 of the second type, in this case each comprising one bit row. Finally (step S35) the different sub-units SS11, SS12, SS13 and SS21, SS22 are assembled or multiplexed to generate the overall channel bitstream BS3 of the full large 2D strip. The latter overall bitstream BS3 is then ready to be transferred over the channel (step S36).

The different steps at the side of the decoder in the proposed 2D coding scheme are shown in FIG. 8. After receiving the channel bitstream BS3′ from the channel (step S40) the as-detected overall channel bitstream BS3′ is demultiplexed (steps S41a, S41b) into the respective parts BS1′ and BS2′ corresponding to each of both sub-unit types. A modulation code decoder 64 corresponding to modulation code encoder 24 decodes (step S42) the as-detected channel bitstream BS2′ of the sub-units of the second type into ECC parities P′ and source data Part-2 D02′. ECC decoding is performed thereafter: at its input (step S43a), the ECC decoder 7 uses the as-detected channel bitstream BS1′ of the sub-units of the first type, the ECC parities P′ and the source data Part-2 DO2′. All these may contain errors due to channel errors in the read-operation, followed by the bit-detection. At its output the ECC decoder 7 produces (step S43b) the error-free (corrected) channel bitstream BS1″ of the sub-units of the first type and the corrected source data Part-2 DO2″. Next, the error-free channel bitstream BS2″ of the sub-units of the first type are decoded by modulation code decoder 63 corresponding to modulation code encoder 23 (step S44), hereby generating the source data Part-1 DO1″. Finally (steps S45a, S45b), the two parts DO1″ and DO2″ of source data are reassembled to generate the overall source data DO, that can then finally be outputted to the user (step S46).

The problem of the application of long codewords (for the first modulation code encoder and decoder) which may lead to error propagation, for example when a single bit is erroneously detected in the channel bitstream which will lead to a wrong word in the bitstream after decoding, is thus avoided according to the present invention by changing the order of the modulation code and the ECC. In that case the ECC will first correct the single bit-error in the channel bitstream or modulation data, and then apply the corrected bit-stream to the modulation code encoder without any error propagation. The reason that this can be done efficiently is the high code-rate of the system. From the point of view of the ECC error correcting capabilities, it is almost equally efficient to put the ECC in front of the modulation code encoder as after the modulation code encoder. For systems with a lower capacity the number of bits to-be-corrected by the ECC for each user bit will increase which leads to a lower efficiency of the ECC. Therefore, for a 152→153 code, which is preferably used as the first modulation code, the order is changed. The resulting parities however still need to be modulation encoded. This is done by the second (lower rate) modulation code, preferably a 12→13 code, that also has the function of separation of strips (or sub-units) of the first type, and glueing such strips (or sub-units) together, as was discussed above.

For the 152→153 modulation code for the sub-units of the first type, this means that a wrong channel word with a length of 153 channel bits arranged as 51 successive fish-bones (each comprising three bits), where the error is due to a single channel bit-error, will not any longer result in a wrong user word of length 152 as it is in the known coding system with the standard order of ECC and MC, where this wrong channel word will be demodulated first into a wrong user word of length 152, which user word subsequently forms the input for the ECC block so that each single bit-error in the channel data will lead to multiple errors at the input of the ECC and will deteriorate the performance of the error correction code through the error propagation.

In the above exemplary description the sub-units of the second type have been chosen to be one bit row high. In general, the sub-unit of the second type can be more than one bit row high, but are preferably less bit rows high than the sub-units of the first type. Further, an implementation on a 2D hexagonal lattice is preferred. However, the present invention is also applicable for any other (regular) 2D lattice, such as, for instance, the square lattice. Still further, more than two modulation codes can also be used.

The second user data DI2 (SD part 2) can also empty. If there are so many parities, e.g. in case large sub-strips with more than 3 rows are concatenated, to fill the intermediate ‘glue’ strip (of said second modulation data) then the second user data DI2 can be empty (similar in the decoder, where the second user data DO2′ and DO2″ will then be empty). The second user data DI2 is mainly present for efficiency reasons in case some space is left in the ‘glue’ strip after all the parities are filled in already. Embodiments of an encoding apparatus and a decoding apparatus where SD part-2 is empty are shown in FIGS. 9 and 10.

The invention is not limited to 2D coding. It can also be used for 3D coding where the first modulation data are arranged in 3D pipes (or tubes) and the second modulation data are arranged in shells around this 3D pipes in order to separate these 3D pipes in every other direction than the tangential direction along the 3D pipes.

The present invention relates to a coding strategy for joint modulation coding and ECC coding. It relates in particular to the situation where 2D coding is performed along one-dimensionally evolving strips containing a number of bit rows in the radial direction of the strip. The idea further relates to high-rate modulation coding. According to the invention, a strip is built up by an alternation of two basic sub-units, each with their own modulation code. The first sub-unit comprises a larger number of bit rows, and its (high-rate) modulation code has a high coding efficiency realized through the use of large codewords. The second sub-unit comprises a single or only few bit rows, and its modulation code has a lower efficiency, which makes it much less sensitive to error-propagation: another function of the sub-unit of the second type is to glue sub-units of the first type together while maintaining the 2D constraint also at the boundaries of the sub-units of the first type. The first sub-unit relates to most or all of the source data, and is encoded first, prior to ECC coding. The second sub-unit relates to the ECC parities, and possibly the remainder of the source data. Both at the encoder and the decoder, special measures are taken related to the precise order of both modulation code encoders (and decoders), and of the ECC encoder (and decoder).

1. An encoding apparatus for multi-dimensionally encoding a user data stream of user data into a channel data stream comprising:
a first modulation code encoding unit (23) having a high code-rate for modulation code encoding said user data (DI) into first modulation data (BS1),
an ECC encoding unit (1) for ECC encoding said first modulation data (BS1) obtaining ECC parity data (P),
a second modulation code encoding unit (24) having a lower code-rate than said first modulation code encoding unit (23) for modulation code encoding said parity data (P) into second modulation data (BS2),
a modulation data combination unit for combining said first and second modulation data (BS1, BS2) into said channel data stream (BS3) comprising at least two bit rows one-dimensionally evolving along a first direction and being aligned with each other along at least a second direction, wherein said first and second modulation data (BS1, BS2) are arranged according to a predetermined order, in particular alternately arranged, in said second direction.

2. An encoding apparatus as claimed in claim 1, further comprising a user data separation unit for separating said user data (DI) into first and second user data (DI1, DI2), wherein:
said first modulation code encoding unit (23) is adapted for modulation code encoding said first user data (DI1) into said first modulation data (BS1),
said ECC encoding unit (1) is adapted for ECC encoding said first modulation data (BS1) and said second user data (DI2) obtaining said ECC parity data (P), and
said second modulation code encoding unit (24) is adapted for modulation code encoding said second user data (DI2) and said parity data (P) into said second modulation data (BS2).

3. An encoding apparatus as claimed in claim 1, wherein said apparatus is adapted for two-dimensionally encoding said user data of said user data stream into said channel data stream along a two-dimensional channel strip of at least two bit rows one-dimensionally evolving along a first direction and being aligned with each other along a second direction, said two directions constituting a two-dimensional lattice of bit positions.

4. An encoding apparatus as claimed in claim 3, wherein said two directions constitute a two-dimensional hexagonal or square lattice of bit positions.

5. An encoding apparatus as claimed in claim 3, wherein said first modulation data (BS1) are arranged along a first type of two-dimensional modulation strip (SS11, SS12, SS13) of at least two bit rows, in particular of three bit rows, one-dimensionally evolving along said first direction and being aligned with each other along said second direction.

6. An encoding apparatus as claimed in claim 3, wherein said second modulation data (BS2) are arranged along a second type of modulation strip (SS11, SS12) of at least one bit row one-dimensionally evolving along said first direction.

7. An encoding apparatus as claimed in claim 5,
wherein said modulation data combination unit is adapted for alternately combining said first and second modulation data (BS1, BS2) to obtain a channel data stream (BS3) comprising three first type modulation strips (SS11, SS12, SS13) each having three bit rows and two second type modulation strips (SS21, SS22) each having one bit row arranged between said three first type modulation strips (SS11, SS12, SS13).

8. An encoding apparatus as claimed in claim 3, wherein said first modulation code encoding unit (23) is adapted for using long codewords, in particular for encoding 152 user bits of said first user data into 153 modulation bits of said first modulation data, in particular using enumerative channel coding.

9. An encoding apparatus as claimed in claim 3, wherein said second modulation code encoding unit (24) is adapted for using short codewords, in particular for encoding 12 user bits of said second user data and said ECC parity data into 13 modulation bits of said second modulation data.

10. An encoding apparatus as claimed in claim 1, wherein said second modulation code encoding unit (24) is adapted for modulation code encoding in such a way that code constraints of said first modulation code are fulfilled when said first and second modulation data (BS1, BS2) are alternately arranged in said channel data stream (BS3)

11. A decoding apparatus for multi-dimensionally decoding a channel data stream of channel data into a user data stream, said channel data stream comprising at least two bit rows one-dimensionally evolving along a first direction and being aligned with each other along at least a second direction, wherein said first and second modulation data (BS1, BS2) are arranged according to a predetermined order, in particular alternately arranged, in said second direction, comprising:
a channel data separation unit for separating said channel data (BS3′) into first and second channel data (BS1′, BS2′),
a second modulation code decoding unit (64) having a low code-rate for modulation code decoding said second channel data (BS2′) into ECC parity data (P′),
an ECC decoding unit (7) for ECC decoding said first channel data (BS1′) and said ECC parity data (P′) obtaining ECC decoded first channel data (BS1″),
a first modulation code decoding unit (63) having a higher code-rate than said second modulation code decoding unit (64) for modulation code decoding said ECC decoded first channel data (BS1″) into ECC decoded user data (DO) forming said user data stream.

12. A decoding apparatus as claimed in claim 11, wherein:
said second modulation code decoding unit (64) is adapted for modulation code decoding said second channel data (BS2′) into second demodulation data (DO2′) and ECC parity data (P′),
said ECC decoding unit (7) is adapted for ECC decoding said first channel data (BS1′), said second demodulation data (DO2′) and said ECC parity data (P′) obtaining ECC decoded first channel data (BS1″) and ECC decoded second user data (DO2″),
said first modulation code decoding unit (63) is adapted for modulation code decoding said ECC decoded first channel data (BS1″) into ECC decoded first user data (DO1″), and
a user data combination unit is provided for combining said ECC decoded first and second user data (DO1″, DO2″) into said user data stream (DO).

13. An encoding method for multi-dimensionally encoding a user data stream of user data into a channel data stream comprising:
a first modulation code encoding step having a high code-rate for modulation code encoding said user data (DI1) into first modulation data (BS1),
an ECC encoding step for ECC encoding said first modulation data (BS1) obtaining ECC parity data (P),
a second modulation code encoding step having a lower code-rate than said first modulation code encoding step for modulation code encoding said parity data (P) into second modulation data (BS2),
a modulation data combination step for combining said first and second modulation data (BS1, BS2) into said channel data stream (BS3) comprising at least two bit rows one-dimensionally evolving along a first direction and being aligned with each other along at least a second direction, wherein said first and second modulation data (BS1, BS2) are arranged according to a predetermined order, in particular alternately arranged, in said second direction.

14. A decoding method for multi-dimensionally decoding a channel data stream of channel data into a user data stream, said channel data stream comprising at least two bit rows one-dimensionally evolving along a first direction and being aligned with each other along at least a second direction, wherein said first and second modulation data (BS1, BS2) are arranged according to a predetermined order, in particular alternately arranged, in said second direction, comprising:
a channel data separation step for separating said channel data (BS3′) into first and second channel data (BS1′, BS2′),
a second modulation code decoding step having a low code-rate for modulation code decoding said second channel data (BS2′) into ECC parity data (P′),
an ECC decoding step for ECC decoding said first channel data (BS1′) and said ECC parity data (P′) obtaining ECC decoded first channel data (BS1″) and ECC decoded user data (D02″),
a first modulation code decoding step having a higher code-rate than said second modulation code decoding step for modulation code decoding said ECC decoded first channel data (BS1″) into ECC decoded user data (DO1″) forming said user data stream (DO).

15. A signal comprising channel data of a channel data stream multi-dimensionally encoded from user data of a user data stream, said signal comprising first and second modulation data (BS1, BS2) combined into said channel data stream comprising at least two bit rows one-dimensionally evolving along a first direction and being aligned with each other along at least a second direction, wherein said first and second modulation data (BS1, BS2) are arranged according to a predetermined order, in particular alternately arranged, in said second direction, wherein:
said first modulation data being modulation code encoded by a first modulation code encoding unit (23) having a high code-rate from user data (DI1), and
said second modulation data being modulation code encoded by a second modulation code encoding unit (24) having a lower code-rate than said first modulation code encoding unit (24) from parity data (P), said parity data being obtained by ECC encoding said first modulation data (BS1).

16. A signal as claimed in claim 15, wherein:
said first modulation data being modulation code encoded from first user data (DI1), and
said second modulation data being modulation code encoded from second user data (DI2) and parity data (P), said parity data being obtained by ECC encoding said first modulation data (BS1) and said second user data (DI2).

17. Storage medium storing a signal as claimed in claim 15.

18. Computer program comprising program code means for causing a computer to implement the steps of the method of claim 13 when said program is run on a computer.
